(19) United States
(12) Patent Application Publication
(10) Pub. No.: US 2011/0298759 A1
(43) Pub. Date: Dec. 8, 2011

(54) Method of Reducing Noises on a Touch Panel

(76) Inventors: Chun-Wei Yang, Hsin-Chu (TW); Chun-Lung Hung, Hsin-Chu (TW); Yu-Min Hsu, Hsin-Chu (TW); Yung-Tse Cheng, Hsin-Chu (TW)

(21) Appl. No.: 12/886,564

(22) Filed: Sep. 21, 2010

(30) Foreign Application Priority Data
Jun. 8, 2010 (TW) 099118624

(51) Int. Cl. G06F 3/041

(52) U.S. Cl. 345/178

(57) ABSTRACT

During test of a display, a synchronous reference signal is determined, and an appearing moment of a minimal-noise signal is determined based on a start moment of the synchronous reference signal. Therefore, during other tests or usage by a user on the display, noise from data lines due to data coupling may be avoided, and detection and determination of touch commands on a touch panel of the display may be isolated from being disturbed by the noise.

### BACKGROUND OF THE INVENTION

1. Field of the Invention

The present invention relates to methods for reducing noise on a touch panel, and more particularly to a method of sampling a signal on a touch panel, and thereby determining optimum charging/discharging periods of a capacitor on the touch panel by finding a moment having lowest noise to reduce noise on the touch panel.

2. Description of the Prior Art

Please refer to FIG. 1, which is a simplified diagram of a display 100 having a touch panel. As shown in FIG. 1, the display 100 comprises a touch panel 110 and a display panel 120. Gate lines (not shown) and data lines (such as data lines D1-D4 shown in FIG. 1) cover the display panel 120 in a matrix pattern, such that the display 100 displays pixel data on the display panel 120 corresponding to a clock signal transmitted over the gate lines and data signals transmitted over the data lines. The touch panel 110 comprises capacitors. By sensing capacitance variations of the capacitors on the touch panel 110, the display 100 can accurately determine a position on the touch panel 110 contacted by a user, thereby discriminating between various single-touch or multi-touch commands triggered by the user. However, because data coupling is very easily generated between the touch panel 110 and the display panel 120 due to coupling capacitors (such as capacitors C1, C2, C3 shown in FIG. 1) between the touch panel 110 and the display panel 120, data signals transmitted over the data lines generate interference in noise form in capacitance detection performed on the touch panel 110, which affects discrimination of the commands or accuracy of pixel data display in the display 100. To prevent such data coupling, decreasing detection frequency utilized for detecting capacitance on the touch panel 110 in order to avoid time for transmitting the data signal over the data line may be feasible in theory. However, the touch panel 110 is unable to detect touch commands triggered by the user in real-time when the detection frequency is too low.

### SUMMARY OF THE INVENTION

According to an embodiment, a method of reducing touch panel noise comprises performing a process comprising determining a synchronous reference signal by at least one type of clock signal utilized on a display panel, utilizing a sensor on a touch panel corresponding to a test position of the display panel to sample a signal at the test position in a first predetermined period for generating a plurality of sample signals, determining a maximum sample signal having maximum magnitude and a minimum sample signal having minimum magnitude of the plurality of sample signals, determining magnitude difference of the maximum sample signal and the minimum sample signal to generate a noise estimation signal, comparing magnitude of the noise estimation signal and magnitude of a current minimum noise estimation signal to generate a comparison result, determining magnitude of the current minimum noise estimation signal according to the comparison result, and determining and recording appearance moment of the current minimum noise estimation signal according to phase difference of the current minimum noise estimation signal relative to the synchronous reference signal and appearance moment of the synchronous reference signal. The method further comprises performing the process iteratively with a second predetermined period as a time interval until a third predetermined period ends, wherein the third predetermined period covers a plurality of the first predetermined periods and a plurality of the second predetermined periods, and driving a plurality of data lines of the display panel according to the synchronous reference signal and the appearance moment of the current minimum noise estimation signal for transmitting data to the display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram of a display having a touch panel.

FIG. 2 is a flowchart of a method of reducing noise on a touch panel according to an embodiment.

FIG. 3 is a timing diagram of signal sampling performed during realization of the steps of FIG. 2.

FIG. 4 is a timing diagram of different types of clock signals utilized on display panel shown in FIG. 1.

### DETAILED DESCRIPTION

To overcome the weaknesses of the prior art described above, including data coupling between the touch panel and the display panel affecting detection of touch commands or pixel data display problems, a method of reducing touch panel noise that includes sampling signals on a touch panel and utilizing the sampled signals to find a minimum noise moment for determining optimum charge/discharge time of capacitors on the touch panel is provided.

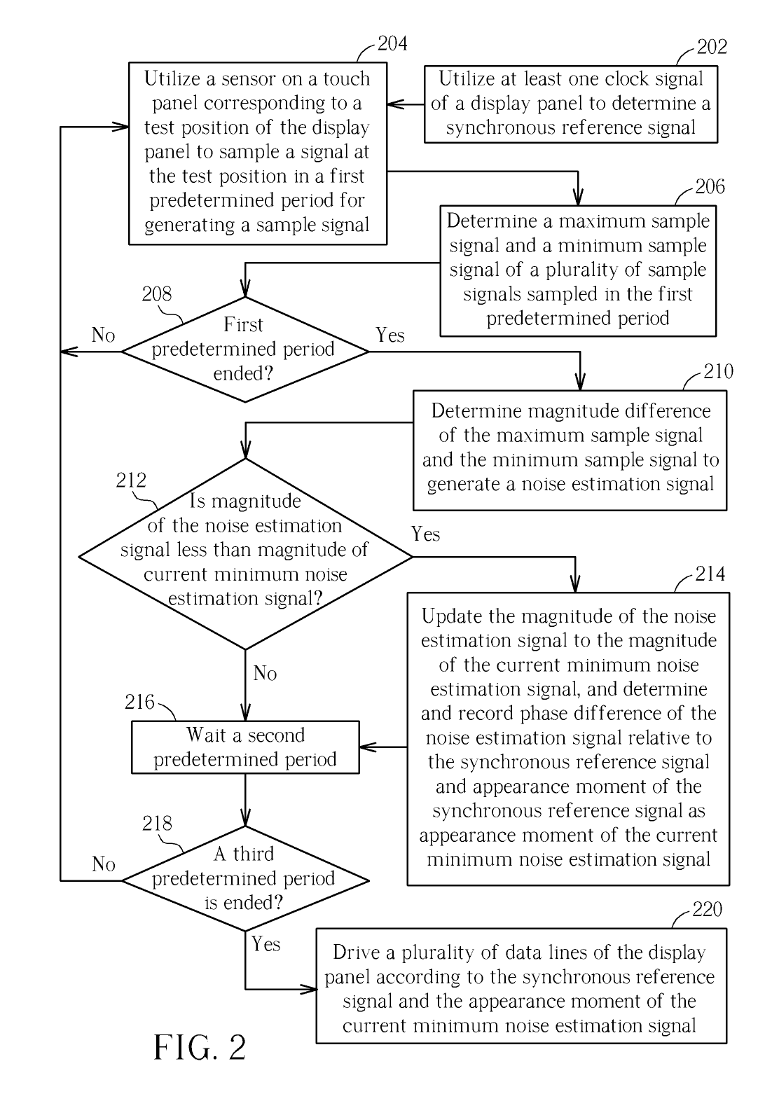

Please refer to FIG. 2, which is a flowchart of a method of reducing noise on a touch panel according to an embodiment. As shown in FIG. 2, the method comprises the following steps:

Step 202: Utilize at least one clock signal of a display panel to determine a synchronous reference signal, and execute Step 204;

Step 204: Utilize a sensor on a touch panel corresponding to a test position of the display panel to sample a signal at the test position in a first predetermined period for generating a sample signal, and execute Step 206;

Step 206: Determine a maximum sample signal having greatest magnitude and a minimum sample signal having least magnitude of a plurality of sample signals already sampled in the first predetermined period, and execute Step 208;

Step 208: Determine whether or not the first predetermined period is ended; when the first predetermined period is ended, execute Step 210, else execute Step 204;

Step 210: Determine magnitude difference of the maximum sample signal and the minimum sample signal to generate a noise estimation signal, and execute Step 212;

Step 212: Compare magnitude of the noise estimation signal and magnitude of a current minimum noise estimation signal, and determine magnitude of the current minimum noise estimation signal according to the comparison result; when the magnitude of the noise estimation signal is less than the magnitude of the current minimum noise estimation signal, execute Step 214, else execute Step 216;

Step 214: Update the magnitude of the noise estimation signal to the magnitude of the current minimum noise estimation signal, and determine and record phase difference of the noise estimation signal relative to the synchronous reference signal and appearance moment of the synchronous reference signal as appearance moment of the current minimum noise estimation signal;

Step 216: Wait a second predetermined period, and execute Step 218;

Step 218: Confirm that a third predetermined period is ended, wherein the third predetermined period covers a plurality of the first predetermined periods and a plurality of the second predetermined periods; when the third predetermined period is ended, execute Step 220, else execute Step 204; and

Step 220: Drive a plurality of data lines of the display panel according to the synchronous reference signal and the appearance moment of the current minimum noise estimation signal currently recorded for outputting data to the display panel.

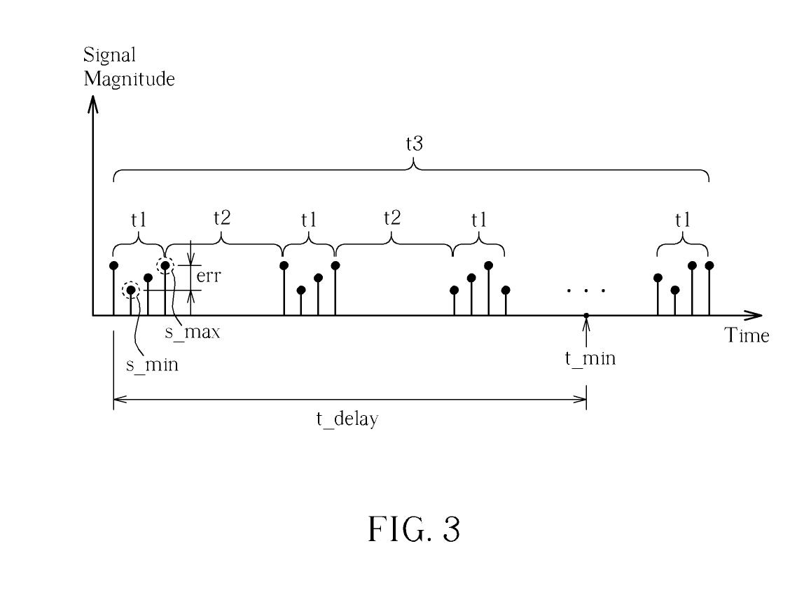

In order to explain the above steps of FIG. 2 clearly, please refer to FIG. 3, which is a timing diagram of signal sampling performed during realization of the steps of FIG. 2. The horizontal axis in FIG. 3 represents time, and the vertical axis represents signal magnitude. FIG. 3 represents signal magnitude detected by a sensor on touch panel 110 corresponding to a test position of display panel 120. The steps of FIG. 2 utilize the signal magnitude as a reference for determining magnitude of noise.

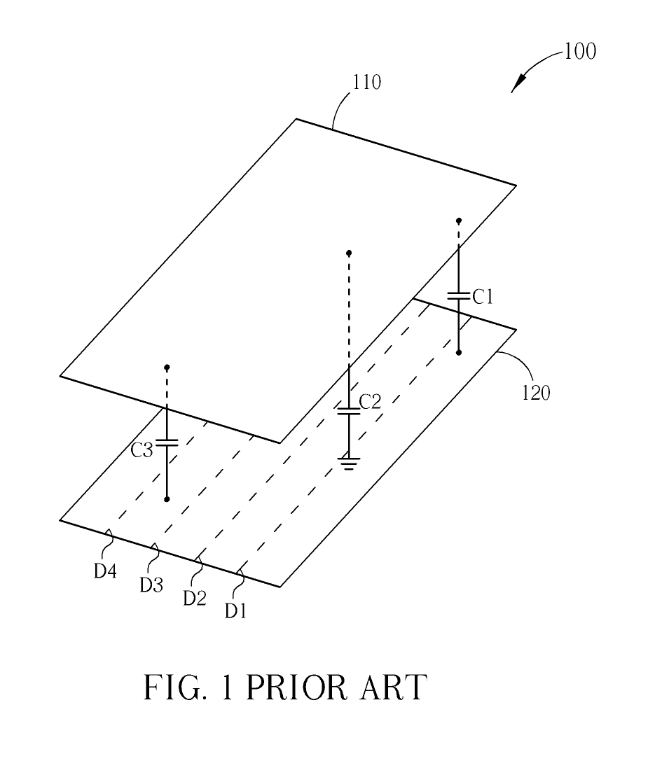

When utilizing the method of FIG. 2 in display 100 shown in FIG. 1, in Step 202, a minimum noise moment t_min (shown in FIG. 3) may be tested in a fixed period. The minimum noise moment t_min may act as a reference moment for later driving of data lines and transmission of data onto display panel 120. Time t3 shown in FIG. 3 represents the fixed period. However, starting moment of the time t3 must first be determined to find phase difference t_delay between the starting moment and the minimum noise moment t_min. Later, when display 100 is practically turned on, as long as starting moment of time t3 and phase difference t_delay are obtainable, position of minimum noise moment t_min on the time axis may be estimated. Starting moment of time t3 is determined by finding a synchronous reference signal out of a plurality of different types of clock signals on display panel 120, and later testing is performed with the synchronous reference signal acting as the starting moment.

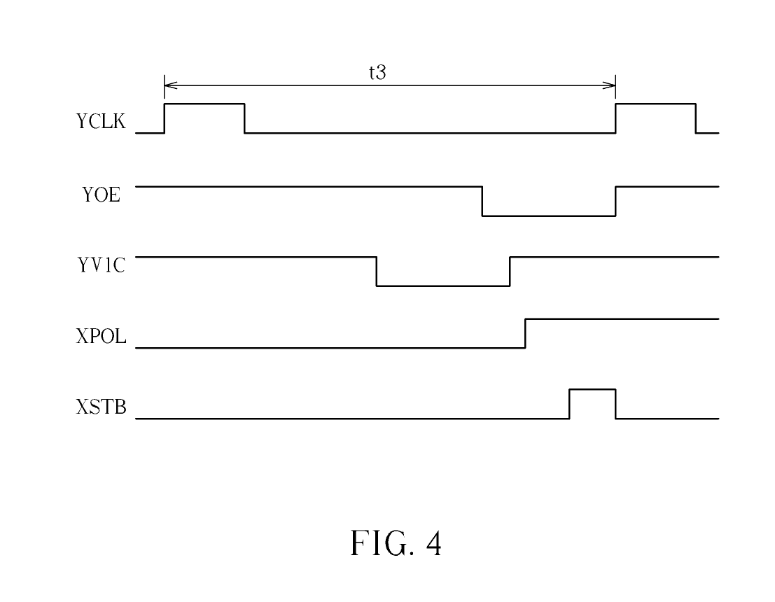

Please refer to FIG. 4, which is a timing diagram of different types of clock signals utilized on display panel 120 shown in FIG. 1. FIG. 4 shows timing of a gate line clock signal YCLK, a gate line switch signal YOE, an edge adjustment signal YV1C, a polarity reverse signal XPOL, and a data storage control signal XSTB, where high and low voltage levels represent enabled and disabled states of each signal. Gate line clock signal YCLK represents a clock utilized by each gate line on display panel 120. Gate line switch signal YOE is utilized for controlling whether or not triggering of gate lines by gate line clock signal YCLK is effective. When gate line clock signal YCLK and gate line switch signal YOE are enabled simultaneously, the corresponding gate line on panel 120 may be triggered and activated. Polarity reverse signal XPOL is utilized for controlling light emitting diodes (LEDs) carried on display panel 120 for realizing polarity reversal of display panel 120. Data storage control signal XSTB is utilized for controlling timing of activation of data lines on panel 120 for performing pixel data storage on display panel 120. It can be seen from FIG. 4 that phase differences between the clock signals are different. If no clock signal may be utilized as synchronous reference signal and as a basis for determining starting moment of time t3, even if magnitude of phase difference t_delay is known, noise cannot be reduced through operation of display 100. In a preferred embodiment, as shown in FIG. 4, a disabled period (duty cycle) of edge adjustment signal YV1C may act as time t3 shown in FIG. 3.

Steps 204-208 correspond to time t1 shown in FIG. 3, and time t1 acts as signal sample time for a single test position on touch panel 110. As shown in FIG. 3, sampling is performed on a sensor on touch panel 110 corresponding to a specific test position of display panel 120 at time t1 to obtain a plurality of discrete sampling signals (as shown in FIG. 3, four signals falling within time t1). In Step 206, a signal having minimum magnitude and a signal having maximum magnitude (which may not be among all sets of four signals shown in FIG. 3) of the plurality of signals already sampled in time t1 are found. In Step 208, when time t1 ends, namely when all four signals covered by time 1 are sampled as shown in FIG. 3, signal s_max having maximum magnitude and signal s_min having minimum magnitude of the four signals shown in FIG. 3 are determined.

In Step 210, magnitude difference between signals s_max, s_min is determined as a noise estimation signal err to act as representative noise of a signal group covered by time t1 shown in FIG. 3 (namely, the set of four signals covered by time t1 shown in FIG. 3). Typically, prior to executing Step 212, display 100 has already gathered noise estimation signals err of a plurality of the abovementioned signal groups, and found noise estimation signal err having minimum signal magnitude to act as a current minimum noise estimation signal. State of the current minimum noise estimation signal prior to time t3 ending is variable. When a new noise estimation signal err is obtained after executing Step 210, signal magnitudes of the new noise estimation signal and the current minimum noise estimation signal are compared in Step 212. When a comparison result shows that signal magnitude of the new noise estimation signal err is less than the current minimum noise estimation signal, related information of the current minimum noise estimation signal is updated to related information of the new noise estimation signal err in Step 214. For example, magnitude and corresponding phase difference t_delay of the current minimum noise estimation signal are updated to magnitude of the new noise estimation signal err and corresponding time difference (phase difference) of the new noise estimation signal err relative to starting moment of time t3. When the comparison result shows that signal magnitude of the new noise estimation signal err is not less than the current minimum noise estimation signal, related information of the current minimum noise estimation signal is maintained, e.g. maintaining magnitude of the current minimum noise estimation signal and phase difference of the current minimum noise estimation signal relative to the synchronous reference signal.

It can be seen from FIG. 3 that sampling is performed on a test position on touch panel 110 with a signal group as a sampling unit, and that every two signal groups are separated by a fixed time t2. The second predetermined period waited for in Step 216 refers to time t2 shown in FIG. 3. Regardless of whether new noise estimation signal err sampled in Step 212 is less than the current minimum noise estimation signal, the method of FIG. 2 waits for time t2 shown in FIG. 3. It can be seen from FIG. 3 that time t3 covers a plurality of times t1, t2. Normally, length of time t1 is much shorter than length of time t2. In Step 218, confirmation of whether or not time t3 is ended to determine whether or not to stop sampling of the test position on touch panel 100. When time t3 is not ended, it means that sampling needs to continue to be performed on the test position, and Step 204 is executed. When time t3 is ended, it means that related information, such as appearance moment, of current minimum noise estimation signal on the test position is already obtained, and Step 220 is executed. Step 220 represents that, once manufacture of display 100 is completed, or when performing later function tests on the display 100, appearance moment of current minimum noise estimation signal currently obtained may be used as a basis for driving capacitors on touch panel 110 to charge/discharge touch panel 110 on condition that estimated noise is minimized, thereby preventing the prior art problem of data coupling causing noise interference in the touch panel, reducing touch panel noise, and increasing accuracy of the touch panel when detecting touch commands.

Please note that times t2, t3 shown in FIG. 3 may be determined by manufacturing or test presets, or by a user manually setting the times t2, t3 of the display 100. Length of time t1 is much less than length of time t2 so as to complete signal sampling within a very short period of time.

A method of reducing noise on a touch panel is described above. In the method, a synchronous reference signal is obtained and set, and starting moment of the synchronous reference signal is a benchmark for obtaining appearance moment of minimum noise during testing, so as to prevent data coupling of data lines causing noise during later tests of the display or use of the display by a user, which would interfere with detection and determination of touch commands on the touch panel.

Those skilled in the art will readily observe that numerous modifications and alterations of the device and method may be made while retaining the teachings of the invention.

What is claimed is:

1. A method of reducing touch panel noise, the method comprising:
performing a process comprising:
determining a synchronous reference signal by at least one type of clock signal utilized on a display panel;
utilizing a sensor on a touch panel corresponding to a test position of the display panel to sample a signal at the test position in a first predetermined period for generating a plurality of sample signals;
determining a maximum sample signal having maximum magnitude and a minimum sample signal having minimum magnitude of the plurality of sample signals;
determining magnitude difference of the maximum sample signal and the minimum sample signal to generate a noise estimation signal;
comparing magnitude of the noise estimation signal and magnitude of a current minimum noise estimation signal to generate a comparison result;
determining magnitude of the current minimum noise estimation signal according to the comparison result; and
determining and recording appearance moment of the current minimum noise estimation signal according to phase difference of the current minimum noise estimation signal relative to the synchronous reference signal and appearance moment of the synchronous reference signal;
performing the process iteratively with a second predetermined period as a time interval until a third predetermined period ends, wherein the third predetermined period covers a plurality of the first predetermined periods and a plurality of the second predetermined periods; and
driving a plurality of data lines of the display panel according to the synchronous reference signal and the appearance moment of the current minimum noise estimation signal for transmitting data to the display panel.

2. The method of claim 1, wherein comparing the magnitude of the noise estimation signal and the magnitude of the current minimum noise estimation signal to generate the comparison result, and determining the magnitude of the current minimum noise estimation signal according to the comparison result comprises:
updating the magnitude of the current minimum noise estimation signal to the magnitude of the noise estimation signal when the magnitude of the noise estimation signal is less than the magnitude of the current minimum noise estimation signal; and
recording the phase difference of the noise estimation signal relative to the synchronous reference signal as phase difference of the current minimum noise estimation signal relative to the synchronous reference signal.

3. The method of claim 1, wherein comparing the magnitude of the noise estimation signal and the magnitude of the current minimum noise estimation signal to generate the comparison result, and determining the magnitude of the current minimum noise estimation signal according to the comparison result comprises:
maintaining the magnitude of the current minimum noise estimation signal and the phase difference of the current minimum noise estimation signal relative to the synchronous reference signal when the magnitude of the noise estimation signal is not less than the magnitude of the current minimum noise estimation signal.

4. The method of claim 1, wherein the at least one type of clock signal comprises an edge adjustment signal utilized for adjusting access sequence of data lines on two sides of the display panel for reducing access delay relative to data lines of a central region of the display panel, and determining the synchronous reference signal by the at least one type of clock signal utilized on the display panel comprises:
selecting the edge adjustment signal as the synchronous reference signal;
wherein length of the third predetermined period is determined according to a duty cycle of the edge adjustment signal.

5. The method of claim 1, wherein lengths of the second predetermined period and the third predetermined period are determined according to a predetermined setting.

6. The method of claim 5, wherein lengths of the second predetermined period and the third predetermined period are further determined according to a user setting.

7. The method of claim 1, wherein lengths of the second predetermined period and the third predetermined period are determined according to a user setting.
